(19) United States
(12) Patent Application Publication
(10) Pub. No.: US 2004/0163121 A1
(43) Pub. Date: Aug. 19, 2004

(54) Digital broadcasting storage device and method using mark-up language

(75) Inventor: Jin Ho Hyun, Kyunggi-do (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/762,811

(22) Filed: Jan. 21, 2004

(30) Foreign Application Priority Data
Jan. 21, 2003 (KR) 3902/2003

(51) Int. Cl. H04N 7/173; H04N 7/16

(52) U.S. Cl. 725/112; 725/109; 725/110; 725/113; 725/135

(57) ABSTRACT

Disclosed is a digital broadcasting storage device using a mark-up language, the storage device including: a user interface unit for allowing broadcasting information to be used or searched; a metadata processing unit for processing and parsing XML (Extensible Markup Language)-formatted broadcasting information received; a storage unit for storing the broadcasting information therein; a searching unit for searching and providing the stored broadcasting information; and a controlling unit for controlling to process, store and search the broadcasting information.

### BACKGROUND OF THE INVENTION

1. Field of the Invention

The present invention relates to a digital broadcasting storage device and method using a mark-up language, and more particularly, to a digital broadcasting storage device and method using a mark-up language in which digital broadcasting information using the mark-up language (XML) can be stored for a personal video recorder (PVR) and a personal digital recorder (PDR) that can receive/store digital broadcasting.

2. Description of the Related Art

Due to a recent supplying expansion and price drop in a hard disc, a PVR and a PDR using a hard disc instead of a recording medium using a conventional analogue tape has appeared to the market.

However, the PVR and the PDR currently on sale are limited to a simple function of storing video or audio, and do not satisfy user's various requirements such as a title search and a genre search.

Currently, an XML (Extension Mark-up Language) has been widely used as a standard of an inter-entrepreneur document exchange on Internet, and the broadcasting information partially using the XML has been carried out even in the digital broadcasting.

it is expected that such a tendency is maintained continuously. It is expected that if the broadcasting information using the XML is increased, the PVR and the PDR can use the XML-formatted broadcasting information to provide the user with various functions.

### SUMMARY OF THE INVENTION

Accordingly, the present invention is directed to a digital broadcasting storage device and method using a mark-up language that substantially obviates one or more problems due to limitations and disadvantages of the related art.

An object of the present invention is to provide a digital broadcasting storage device and method using a mark-up language in which XML-formatted broadcasting information is used in a digital broadcasting environment such that various functions and information can be provided for the user.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provide a digital broadcasting storage device using a mark-up language, the storage device including: a user interface unit for allowing broadcasting information to be used or searched; a metadata processing unit for processing and parsing XML (Extensible Markup Language)-formatted broadcasting information received; a storage unit for storing the broadcasting information therein; a searching unit for searching and providing the stored broadcasting information; and a controlling unit for controlling to process, store and search the broadcasting information.

The metadata processing unit further includes a preference extracting unit for extracting a preference that is directly inputted by a user or that is automatically created from a watch record.

The searching unit searches using a title, a keyword, a genre and the like according to a user's request of the stored broadcasting information, and provides the searched information for the user through the user interface unit.

The controlling unit includes: a database managing unit for managing information of the storage unit; a media file system managing unit for managing a file system; and a media router for controlling a peripheral device.

The metadata processing unit includes: a media management engine for managing record or reproduction of a video/audio; a metadata processing engine for previously processing and storing the XML-formatted information; and an XML parsing engine for parsing the stored XML-formatted information.

In another aspect of the present invention, there is provided a digital broadcasting storage method using a mark-up language, the storage method including: receiving XML-based broadcasting information to extract metadata; processing, parsing and storing the extracted metadata; and searching the stored metadata in response to a user's request to provide the broadcasting information.

The broadcasting information is searched reflecting a user preference.

The user preference is directly inputted by a user or is automatically created from a user's watch record.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a total construction of a digital broadcasting storage device using a mark-up language according to a preferred embodiment of the present invention;

FIG. 2 is a view illustrating a navigator and a program guide and search engine;

FIG. 3 is a view illustrating an XML parsing engine and a metadata processing engine;

FIG. 4 is a view illustrating a preference engine;

FIG. 5 is a view illustrating a structure of a metadata processing engine;

FIG. 6 is a view illustrating an operation of a metadata processing engine; and

FIG. 7 is a view illustrating a metadata information extractor.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

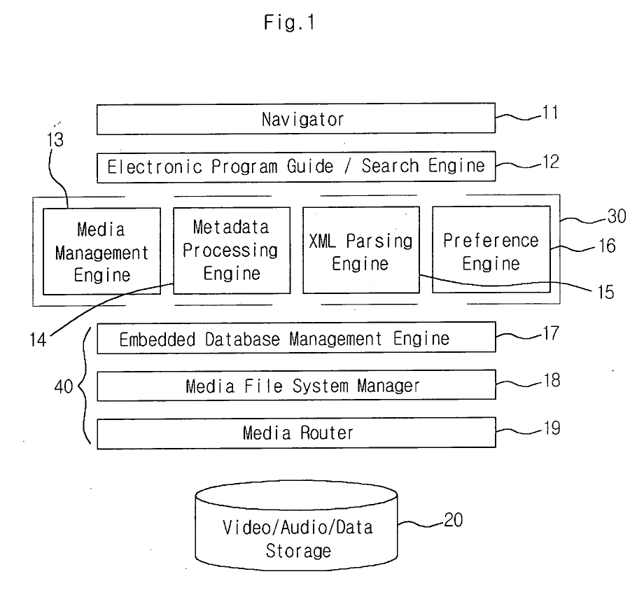

FIG. 1 is a view illustrating a total construction of a digital broadcasting storage device using a mark-up language according to a preferred embodiment of the present invention.

Referring to FIG. 1, the digital broadcasting storage device using the mark-up language according to the present invention includes a navigator 11 for performing an interfacing function with a user; a program guide and search engine 12 for searching and extracting broadcasting information stored; a metadata processing unit 30 for parsing and processing XML-formatted broadcasting information; a device driver unit 40 for allowing storage, management and search of video and broadcasting information, and controlling a peripheral device; and a storage medium 20 for storing audio, video and broadcasting information therein.

The navigator 11 is a user interface constructing a screen that a user actually uses, and the program guide and search engine 12 searches the stored program guide and the stored broadcasting information into which XML-formatted information is previously processed.

The metadata processing unit 30 includes a media management engine (MME) 13 for managing record, reproduction and the like of the video/audio; a metadata processing engine (MPE) 14 for previously processing and storing the XML-formatted information; and an XML parsing engine 15 for parsing the XML-formatted information stored by the MPE 14.

Further, it is desirable that the metadata processing unit 30 includes the preference engine 16 for extracting the user preference.

The device driver unit 40 includes an embedded database management engine 17 for performing the storage, management and search of the XML-formatted information and information needed for recording and reproducing the video/audio; a media file system manager (MFSM) 18 for managing a file system for the digital broadcasting storage device; and a media router (MR) 19 for performing a function of a device driver for controlling the peripheral device.

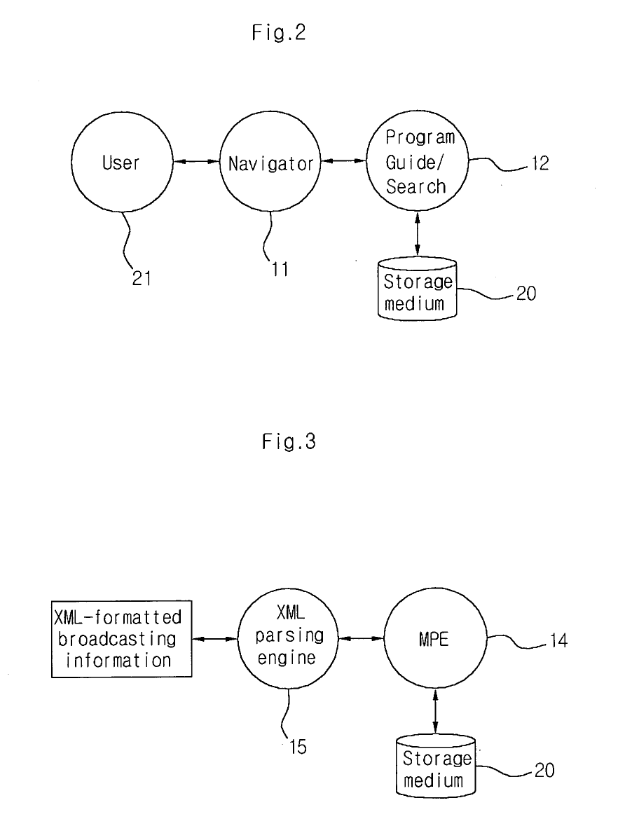

In more detail, as shown in FIG. 2, the navigator 11 corresponds to the user interface and constructs the screen that the user actually uses. The user 21 can watch or record/reproduce its own wanting broadcasting through the navigator 11.

Further, a broadcasting searching function is used for the XML-formatted broadcasting information to enable the user to search/use its own wanting broadcasting program.

The program guide and search engine 12, as shown in FIG. 2, represents a program schedule, which is being broadcasted in the future and is obtained from the XML-formatted information transmitted together with the video/audio in the digital broadcasting environment. The program guide and search engine 12 performs search of title, keyword and genre and the like depending on a user's request of the stored broadcasting information into which the XML-formatted information is previously processed, and shows the searched result to the user.

The MME 13 allows a function of a personal video recorder (PVR) such as time shifting, recording, reproducing and the like of the video/audio, and allows a trick play (forward/backward fast winding, slow reproduction, stop and the like) when the time is shifted or the recorded program is reproduced.

As shown in FIG. 3, the MPE 14 functions to previously process the transmitted XML-formatted broadcasting information in the digital broadcasting environment to store it in a database. The XML parsing engine 15 uses the MPE 14 to store the transmitted XML-formatted broadcasting information, and parses information such that the user can use the parsed information.

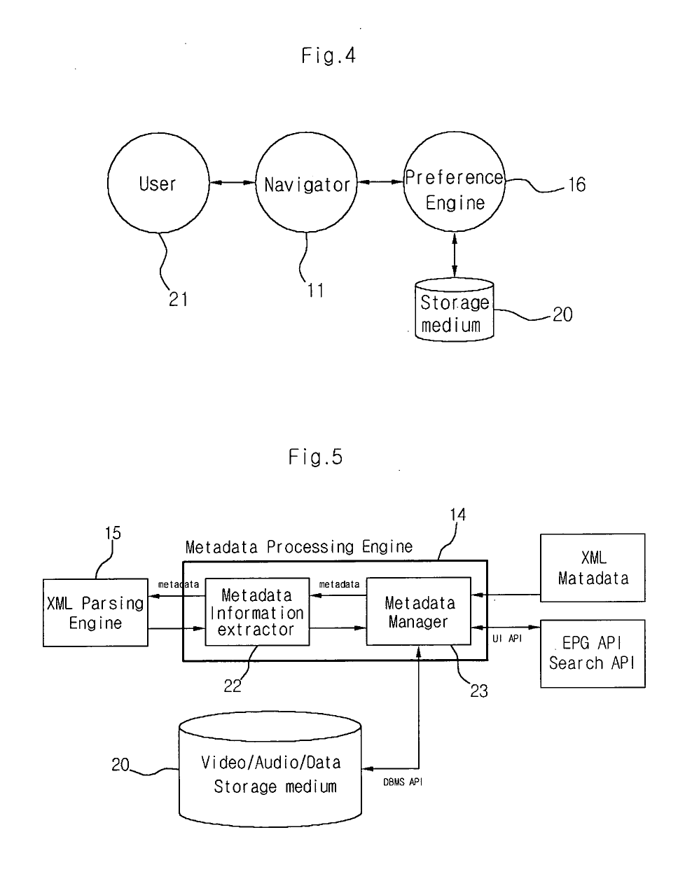

As shown in FIG. 4, the preference engine 16 creates the program guide only for the corresponding user 21, or extracts the user preference program so as to automatically record the user preference program according to an indirect preference. The preference is directly inputted by the user 21 through the navigator 11 or is automatically created from the watch record stored in the storage medium 20 of the user.

The embedded database management engine 17 performs a function of the storage, management and search of the XML-formatted information and the information needed for recording and reproducing the video/audio, and allows optimization of database storage, management and search adapted to an embedded environment of the storage device.

The MFSM 18 for managing the file system for the storage device allows the storage and reproduction of the digital broadcasting video/audio, and allows the storage/search of information for managing the storage device.

The MR 19 functions as the device driver for controlling the peripheral device to enable to manage the digital broadcasting storage device.

The storage medium 20 is a physical space for storing the video/audio therein, and is a space such as a hard disc for storing information for managing the PVR and the PDR as well as the video/audio.

The MPE 14 is described in detail with reference to FIG. 5.

The MPE 14 includes a metadata information extractor 22 and a metadata manager 23. The metadata manager 23 receives XML-based metadata inputted from an upper module, an electronic programming guide application programming interface (EPG API) and a search API.

The MPE 14 uses a user interface (UI) API to allow EPG information and SEARCH information to be displayed, and uses a database management system API to store necessary data in the storage medium 20.

Further, the metadata information extractor 22 receives the metadata from the metadata manager 23 to extract the necessary information from the XML-based metadata by interaction with the XML parsing engine 15. The extracted information is effectively stored and managed in the storage medium 20 by using a database management system (DBMS) API.

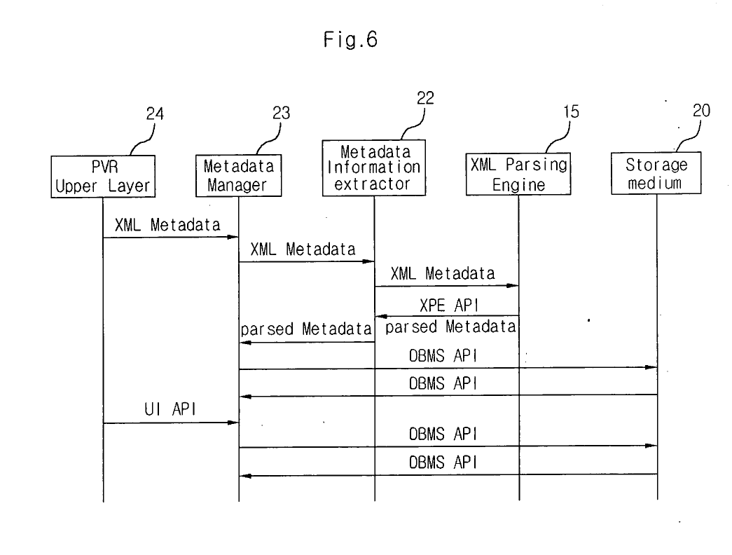

As shown in FIG. 6, the XML-based metadata inputted from the upper module (PVR UPPER LAYER) 24 is processed via the metadata information extractor 22 and the XML parsing engine 15 through the metadata manager 23 to be stored in the storage medium 20.

In other words, the present invention stores the broadcasting information in the storage medium 20 through the step of receiving the XML-based broadcasting information to extract the metadata, and the step of processing, parsing and storing the metadata, and searches the stored metadata in response to the user's request to provide the broadcasting information.

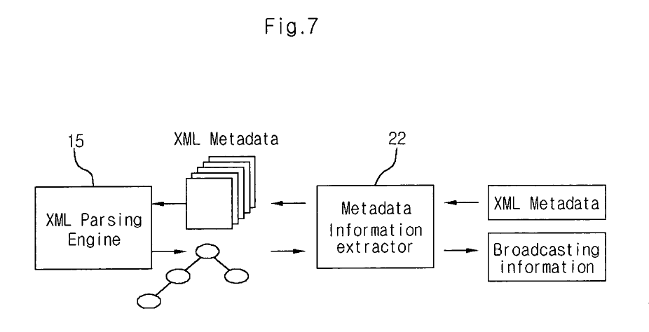

FIG. 7 is a view illustrating the metadata information extractor.

The metadata information extractor 22 receiving the XML metadata parses the metadata through the XML parsing engine 15 to provide the broadcasting information through the metadata information extractor 22.

In other words, the metadata information extractor 22 extracts wanted information from the parsing metadata.

As described above, the present invention has an advantage in that the broadcasting information is extracted from the XML-based metadata in the digital broadcasting environment to enable use of the storage, search and the like such that more conveniences and various functions can be provided for the user.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A digital broadcasting storage device using a mark-up language, the storage device comprising:
user interface means for allowing broadcasting information to be used or searched;
metadata processing means for processing and parsing XML (Extensible Markup Language)—formatted broadcasting information received;
storage means for storing the broadcasting information therein;
searching means for searching and providing the stored broadcasting information; and
controlling means for controlling to process, store and search the broadcasting information.

2. The storage device according to claim 1, wherein the metadata processing means further comprises preference extracting means for extracting a preference that is directly inputted by a user or that is automatically created from a watch record.

3. The storage device according to claim 1, wherein the searching means searches using a title, a keyword, a genre and the like according to a user's request of the stored broadcasting information, and provides the searched information for the user through the user interface means

4. The storage device according to claim 1, wherein the controlling means comprises:
database managing means for managing information of the storage means;
media file system managing means for managing a file system; and
a media router for controlling a peripheral device.

5. The storage device according to claim 1, wherein the metadata processing means comprises:
a media management engine for managing record or reproduction of a video/audio;
a metadata processing engine for previously processing and storing the XML-formatted information; and
an XML parsing engine for parsing the stored XML-formatted information.

6. A digital broadcasting storage method using a mark-up language, the storage method comprising:
receiving XML-based broadcasting information to extract metadata;
processing, parsing and storing the extracted metadata; and
searching the stored metadata in response to a user's request to provide the broadcasting information.

7. The storage device according to claim 6, wherein the broadcasting information is searched reflecting a user preference.

8. The storage device according to claim 7, wherein the user preference is directly inputted by a user or is automatically created from a user's watch record.
